(19) United States
(12) Patent Application Publication
(10) Pub. No.: US 2023/0185241 A1
(43) Pub. Date: Jun. 15, 2023

(54) BALANCE WITH INERTIA ADJUSTMENT

(71) Applicant: Nivarox-FAR S.A., Le Locle (CH)

(72) Inventors: Laurent JEANNERET, Villers-le-Lac (FR); Emmanuel GRAF, Le Locle (CH); Marco VERARDO, Les Bois (CH)

(73) Assignee: Nivarox-FAR S.A., Le Locle (CH)

(21) Appl. No.: 17/815,392

(22) Filed: Jul. 27, 2022

(30) Foreign Application Priority Data
Dec. 10, 2021 (EP) 21213656.8

(51) Int. Cl. G04B 17/06; G04B 17/20; G04B 18/00

(52) U.S. Cl. CPC G04B 17/063; G04B 17/20; G04B 18/006

(57) ABSTRACT

A balance for a horological movement includes rigid portions consisting of a hub defining the pivot axis of the balance, a felloe, four arms connecting the felloe to the hub, and including four slots for receiving and gripping in position an inertia-block, each slot being delimited by an arm and by an elastic arm including a first end integral with the arm, and a second distal end free in relation to the hub, to the arm, and to the felloe sector. The balance includes two pairs of inertia-blocks, each pair of inertia-blocks having different masses to ensure different adjusting powers, a first pair of inertia-blocks for a basic adjustment, and second pair of inertia-blocks for a precise adjustment.

### TECHNICAL FIELD OF THE INVENTION

The invention relates to a balance with inertia adjustment having means for adjusting inertia.

The invention also relates to a horological movement comprising such a system as well as a timepiece equipped with such a movement.

### TECHNOLOGICAL BACKGROUND

It is known a balance of which the moment of inertia is adjustable by means of adjustment screws that are disposed around its periphery. This type of device is known in particular within mechanical oscillators of which the base frequency of the oscillator is adjusted by the moment of inertia of the balance. Generally, such a balance comprises a felloe, arms and a certain arrangement of screws or inertia-blocks fastened on the felloe or the arms of the balance that make it possible, by adjusting their positions, to modify the moment of inertia of the balance. These screws or inertia-blocks are positioned by means of spanners or screwdrivers that make it possible to adjust their position.

It is for example known from patent CH264669 a balance provided with adjustment screws devoid of heads that are screwed from the exterior of the balance felloe and that are embedded in its thickness. This embodiment advantageously aims to replace balances equipped with screws of which the heads are disposed either protruding around the periphery of the felloe, or in a hollow of the felloe.

It is also known from patent EP1837719B1 a balance felloe including studs radially directed towards the interior of the balance, which are each traversed by a threaded hole in order to receive inertia-blocks that are screwed from the interior of the balance. In this configuration, the gripping of the inertia-blocks is not easy, and the balance felloe thus risks being marked during the adjustment.

These balances with adjustment screws also have another drawback that is the difficulty of guaranteeing an adjustment established during the operation of the movement, one or more screws being able to partially or completely unscrew, which is detrimental to the correct operation and to the regularity of the balance.

### SUMMARY OF THE INVENTION

In particular, the aim of the invention is to overcome the various drawbacks of these known techniques.

More specifically, one objective of the invention is to provide a balance with inertia adjustment for an easy and quick adjustment.

Another objective of the invention, at least in one particular embodiment, is to provide a balance with inertia adjustment that is simple to implement and inexpensive to produce.

These objectives, as well as others that will become apparent in the following, are achieved according to the invention with the aid of a balance for horological movement, comprising rigid portions consisting of a hub defining the pivot axis of said balance, a felloe, four arms connecting said felloe to the hub, and including four slots for receiving and gripping in position an inertia-block, each slot being delimited on the one hand by an arm, and on the other hand by an elastic arm including a first end integral with said arm, and a second distal end free in relation to said hub, to said arm, and to said felloe sector.)

According to the invention, the balance comprises two pairs of inertia-blocks, each pair of inertia-blocks having different masses to ensure different adjusting powers, a first pair of inertia-blocks for a basic adjustment, and a second pair of inertia-blocks for a precise adjustment.

In accordance with other advantageous variants of the invention:
each pair of inertia-blocks has different dimensions, the inertia-blocks of the first pair being larger than the inertia-blocks of the second pair, or vice versa;
the inertia-blocks of the first pair are heavier than the inertia-blocks of the second pair, or vice versa;
the pairs of inertia-blocks are made from a different material;
the inertia-blocks of the first pair and the inertia-blocks of the second pair are disposed on a distinct radius of the balance;
the inertia-blocks of the first pair are disposed on a first radius close to the felloe and the inertia-blocks of the second pair are disposed on a second radius close to the hub of the balance;
the arms, the felloe and the hub form a one-piece element.

The invention also relates to a horological movement comprising a balance in accordance with the invention.

The invention also relates to a timepiece comprising a horological movement in accordance with the invention.

### BRIEF DESCRIPTION OF THE FIGURE

Other features and advantages of the invention will become more apparent upon reading the following description of a particular embodiment of the invention, given by way of simple illustrative and non-limiting example, and the appended FIGURE, wherein:

FIG. 1 is a perspective view of a balance in accordance with the invention according to a first embodiment.

### DETAILED DESCRIPTION OF THE INVENTION

The balance 1 for horological movement, equipped with a device for adjusting its inertia making it possible to adjust the oscillation frequency of said balance, comprises rigid portions consisting of a hub 2 defining the pivot axis A of the balance 1, a circular-shaped felloe 3, four arms 4 connecting said felloe 3 to the hub 2, and including four slots 7 for receiving and gripping in position an inertia-block 6,6′.

Each slot 7 is delimited on the one hand by an arm 4, and on the other hand by an elastic arm 5 including a first end 5B integral with said arm 4, and a second distal end 5A free in relation to said hub 2, to said arms 4, and to said felloe sector 3.

As illustrated, the balance 1 comprises four arms, forming a hub 4 at their intersection, the hub 4 being equipped with an orifice 40 intended to receive a balance arbor.

The slot 7 is delimited by a rigid portion of the arm 4 and by an elastic arm 5 that continuously returns towards the arm 4 when the inertia-block is inserted into the slot 7.

According to the invention, the balance comprises two pairs of inertia-blocks 6, 6′, each pair of inertia-blocks having different dimensions to ensure different adjusting powers, a first pair of inertia-blocks 6 for a basic adjustment, and second pair of inertia-blocks 6′ for a precise adjustment.

The inertia-blocks 6, 6′ of each pair are disposed in slots 7 opposite in relation to the pivot axis A of the balance, or also disposed according to an axial symmetry of axis A, for a balanced distribution of the masses on the balance 1.

So as to distinguish the inertia-blocks 6, 6′ and position them correctly, the inertia-blocks 6 of the first pair are larger than the inertia-blocks 6′ of the second pair, or vice versa.

According to one embodiment of the invention, the inertia-blocks 6 of the first pair and the inertia-blocks 6′ of the second pair are disposed on a distinct radius of the balance.

For example, the inertia-blocks 6 of the first pair are disposed on a first radius close to the felloe 3 and the inertia-blocks 6′ of the second pair are disposed on a second radius close to the hub 2 of the balance, the pair of inertia-blocks 6′ close to the hub 2 of the balance for a precise adjustment.

Similarly, the inertia-blocks 6 of the first pair are heavier than the inertia-blocks 6′ of the second pair, or vice versa. For this, various materials may be used to produce the inertia-blocks 6,6′. For example, the inertia-blocks 6 are made from gold or gold alloy such as 18K 3N gold, and the inertia-blocks 6′ are made from titanium or titanium alloy such as grade 5 titanium.

The inertia-blocks 6,6′ comprise a head 61 in the form of a disc and optionally a cylinder-shaped foot 62.

Advantageously, the slot 7 has a shape complementary to that of the head 61 or of the foot 62 of the inertia-block 6, 6′. This embodiment is particularly advantageous because it makes it possible to limit the thickness of the balance 1 once the inertia-blocks 6,6′ have been mounted on the balance 1.

During the installation of the inertia-blocks 6,6′ into the slots 7, the inertia-blocks 6,6′ are gripped in the slots 7 and are held by friction in their position under the effect of the elasticity of the elastic arm 5.

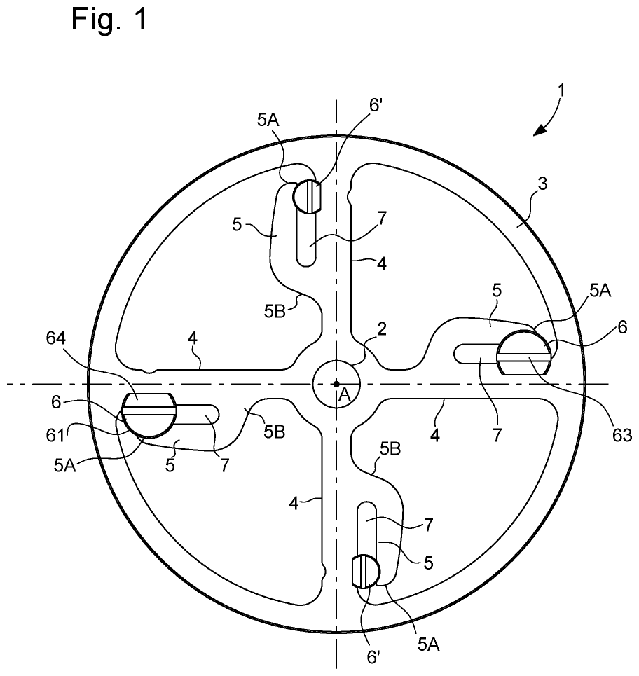

The adjustment inertia-blocks 6,6′ are equipped with a slot 63 to adjust the angular position of the inertia-block by means of a tool cooperating with the slot 63 to transmit a torque about the axis of rotation of the inertia-block 6,6′. According to the embodiment illustrated in FIG. 1, each inertia-block 6,6′ has an uneven part 64 on the disc forming the head 61.

Obviously, the person skilled in the art will know how to adapt the balance 1 and install any other type of inertia-block 6,6′ so as to be able to adjust the inertia of the balance 1.

Such a configuration therefore makes a simple and quick adjustment of the balance possible, the larger and/or heavier inertia-blocks firstly making it possible to perform a basic adjustment, and the smaller and/or lighter inertia-blocks secondly making it possible to refine the adjustment.

The invention also relates to a horological movement and a timepiece equipped with a balance in accordance with the invention.

Thanks to these various aspects of the invention, we have a compact balance for adjusting the position of inertia-blocks that is easy and inexpensive to manufacture.

Of course, the present invention is not limited to the example illustrated and is susceptible to various variants and modifications that will become apparent to the person skilled in the art.

1-10. (canceled)

11. A balance for a horological movement, comprising:
rigid portions including a hub defining the pivot axis of said balance, a felloe, four arms connecting said felloe to the hub, and including four slots to receive and grip in position an inertia-block, each slot being delimited by an arm and by an elastic arm including a first end integral with said arm, and a second distal end free in relation to said hub, to said arm, and in relation to the felloe; and
two pairs of inertia-blocks, each pair of inertia-blocks having different masses to ensure different adjusting powers, the two pairs of inertia-blocks including a first pair of inertia-blocks for a basic adjustment and a second pair of inertia-blocks for a precise adjustment.

12. The balance according to claim 11, wherein the inertia-blocks of each of the two pairs are disposed in the slots opposite in relation to the pivot axis of the balance.

13. The balance according to claim 11, wherein each pair of inertia-blocks has different dimensions, the inertia-blocks of the first pair being larger than the inertia-blocks of the second pair, or the inertia-blocks of the second pair being larger than the inertia-blocks of the first pair.

14. The balance according to claim 11, wherein the inertia-blocks of the first pair are heavier than the inertia-blocks of the second pair, or the inertia-blocks of the second pair are heavier than the inertia-blocks of the first pair.

15. The balance according to claim 11, wherein the inertia-blocks of the first pair are made from a different material that the inertia-blocks of the second pair.

16. The balance according to claim 11, wherein the inertia-blocks of the first pair and the inertia-blocks of the second pair are disposed on a distinct radius of the balance.

17. The balance according to claim 16, wherein the inertia-blocks of the first pair are disposed on a first radius closer to the felloe than the hub and the inertia-blocks of the second pair are disposed on a second radius closer to the hub of the balance than the felloe.

18. The balance according to claim 11, wherein the arms, the felloe, and the hub form a one-piece element.

19. A horological movement comprising:
the balance according to claim 11.

20. The timepiece comprising:
the horological movement according to claim 19.
